(19) United States
(12) Patent Application Publication
(10) Pub. No.: US 2009/0271288 A1
(43) Pub. Date: Oct. 29, 2009

(54) CATEGORY EXPERT WORKBENCH

(75) Inventors: James C. Chong, Orinda, CA (US); Robert M. Lee, JR., Oakland, CA (US); Albert C. Loh, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wigix, Inc., Oakland, CA (US)

(21) Appl. No.: 12/431,481

(22) Filed: Apr. 28, 2009

Related U.S. Application Data
(60) Provisional application No. 61/048,907, filed on Apr. 29, 2008.

(51) Int. Cl. G06Q 30/00; G06Q 10/00; G06F 17/30

(52) U.S. Cl. 705/26; 705/28; 707/104.1

(57) ABSTRACT

A computer system is provided that maintains information about products and provides for transactions between users buying and selling those products as well as providing a public exchange for valuing those products. The system also tracks the users who set up products in the system as well as maintain product categories. That tracking can be used for sharing revenue related to those products with the users, controlling which users become “experts” for a category of products or specific products, allowing for user-to-user interactions, etc. Users can apply to become category experts, and users who do become category experts are allowed to control the taxonomy of a product category and given other administrative controls over the product category.

This application claims priority to U.S. Provisional Application No. 61/048,907 entitled “Category Expert Workbench” filed on Apr. 29, 2008, which is hereby incorporated in its entirety for all purposes. Additionally, this application is related to U.S. application Ser. No. 12/188,100 entitled “Client-Server System For Managing an Item Database and Item Transactions with User-Item Associations” filed on Aug. 7, 2008, which is hereby incorporated in its entirety for all purposes.

### FIELD OF THE INVENTION

The present invention relates to an online item and product management system that is associated with an online category management system. In particular, the present invention relates to a product management system wherein users of the system can become category experts and manage categories and associated SKUs in the online item and product management system.

### BACKGROUND

The Internet has provided amazing opportunities to connect people and provide information. However, it is sometimes difficult to obtain all of the information people need, especially when the domain of the information is quite large. For example, if the domain of information is products, there are a great many products that users might be interested in. Additionally, different users may be searching for different pieces of information about a product. For example, some users may want to buy or sell a product, while other user may want to value products they already have. Still other users may simply wish to learn more about a product.

Many resources on the Internet can help solve aspects of this problem. For example, search engines can be used to find web pages with relevant content. Discussion boards, newsgroups, and blogs on the Internet can also be used to find information. However, all of these sources of information can at times be incomplete, untrustworthy, or difficult to find for one reason or another.

It would be desirable to have a centralized location where information on a variety of products could be easily found and where those products can be easily exchanged between users of this centralized community.

Embodiments of the present invention relate to an online category management system and related taxonomy in which products are classified in a structured fashion. In many prior systems, the taxonomy that is used to organize, classify, and give structure to items in online item and product management systems is controlled by an administrator of the system. Using an administrator to create the taxonomy of the product management system presented some problems. For example, systems that relied upon system administrators to create the taxonomy of the online category management system may not always update their category listings as quickly and efficiently as the users of the system might like. Additionally, a system administrator may not be particularly knowledgeable about various categories in the system, and the taxonomy decisions made by such an administrator may not always be the decisions that well-versed users would prefer. These problems can make it more difficult for users of the system to find the products and information they seek.

Embodiments of the present invention improve on these prior systems by allowing select users to become category experts. A user may apply to become a category expert for one or more categories in which the user has particular expertise or other qualities that would make for a good category expert. According to some embodiments, a utility can be developed for eligible candidates to apply to become category experts. A successful category applicant can create, modify, edit, and manage information about a specific category and its taxonomy together with the products. Additionally, a user selected to become a category expert can use a category expert workbench to create, manage, and maintain a category together with the associated taxonomy for a structured product classification. Embodiments of this system can enhance the relevance and accuracy in searching product information within a particular category on the Internet. The collection of these categories will produce a catalog in which the general public can use to add, browse and search product information and their related meta-data such as ownership and pricing information.

In addition, the workbench or utility empowers category experts to perform category management tasks such as the review and approval of stock keeping units (SKUs), engage in community forums, discussion, and networking, and foster the growth of the category in term of the number of SKUs created. The category structure is intimately linked to a product management system wherein users can add a SKU, provide information about the SKU, and lay claim to it to share in a portion of the revenues. Likewise, the category expert will also be rewarded in a similar fashion by having a share of the revenues generated by advertisement and transaction fees within the category.

Embodiments of the present invention address these and other problems.

### BRIEF SUMMARY

In an embodiment of the present invention, a computer system is provided that maintains information about products and provides for transactions between users buying and selling those products as well as providing a public exchange for valuing those products. The system also tracks the users who set up products in the system as well as maintain product categories. That tracking can be used for sharing revenue related to those products with the users, controlling which users become “experts” for a category of products or specific products, allowing for user-to-user interactions, etc.

According to one embodiment, an apparatus for managing one or more categories and one or more SKUs associated with the one or more categories is disclosed. The apparatus comprises an item database and an item server coupled to the item database. The item server is capable of reading and modifying the item database. The item database comprises a table of categories and a table of SKUs. One or more SKUs stored within the table of SKUs is associated with one or more categories stored in the table of categories. A plurality of users have the ability to create one of more SKUs in the table of SKUs via the item server. A category expert is associated with one or more categories. The category expert has the ability to create and modify the one or more categories associated with the category expert within the table of categories via the item server. The category expert is one of the plurality of users.

According to one embodiment, a method is disclosed for managing one or more categories and one or more SKUs associated with the one or more categories in a product management system. The product management system comprises an item database and an item server, wherein the item server is coupled to the item database and wherein the item server is capable of reading and modifying the item database. The item database comprises a table of categories and a table of SKUs. The method comprises giving a category expert the ability to create and modify one or more categories in the table of categories. The category expert is selected from a plurality of users. The method then publishes the one or more categories to the plurality of users so that the plurality of users have permission to view the one or more categories. Next, the plurality of users are given the ability or create one or more SKUs in the table of SKUs, wherein the SKUs are associated with the one or more categories.

### BRIEF DESCRIPTION OF THE DRAWINGS

FIG. 1 is an illustration of a computer system suitable for use with the present invention.

FIG. 2 is a simplified block diagram of a computer system that may incorporate embodiments of the present invention.

FIG. 3 is a schematic diagram of a network over which an embodiment of the present invention may be used.

FIG. 4 is a simplified block diagram of an item database structure which an embodiment of the present invention may use.

FIG. 5 is an illustration of the process in which any member of the general public can apply to become a category expert according to one embodiment.

FIG. 6 is an example screenshot of an application that illustrates how the general public can apply to become a category expert according to one embodiment.

FIG. 7 is an example screenshot of an application that illustrates how the general public can apply to become a category expert according to one embodiment.

FIG. 8 is an example screenshot of an application that shows information that an administrator may review according to one embodiment.

FIG. 9 is an example screenshot of an application that shows an overall category management process according to one embodiment.

FIG. 10 an example screenshot of an application that shows a building block in the creation of a category according to one embodiment.

FIG. 11 an example screenshot of an application that shows a template used to define product attributes according to one embodiment.

FIG. 12 is an example screenshot of an application that shows item and owner-specific attributes for a category according to one embodiment.

FIG. 13 an example screenshot of an application that shows how attributes can be used to formulate the SKU names according to one embodiment.

FIG. 14 is an example screenshot of an application that shows a template that can be used for defining how a category may be searched by its brand, price, gender, or other characteristic that is defined by the category expert according to one embodiment.

FIG. 15 is an example screenshot of an application that shows how a building block can be used to define how one attribute is related to another according to one embodiment.

FIG. 16 is an example screenshot of an application that shows how a category expert can arrange the order in which the attribute values appear according to one embodiment.

### DETAILED DESCRIPTION

An improved product management, transaction and presentation system is described herein. According to some embodiments, a category expert can set the rules for SKU (Stock Keeping Unit) entry and templates, in effect providing their expertise to the SKU entry process.

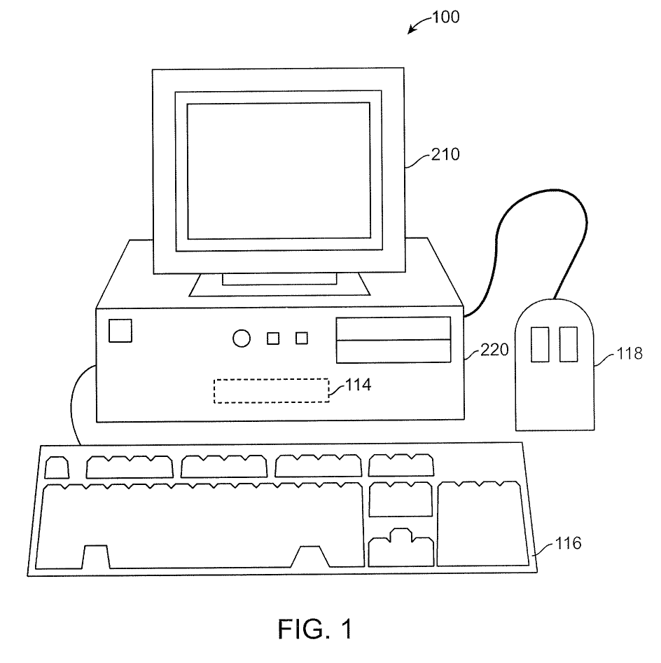

FIG. 1 is an illustration of a computer system 100 suitable for use with the present invention. The computer system 100 can include components such as a computer 220, storage devices such as a hard drive 114, input devices such as a keyboard 116 and mouse 118, and output devices such as a monitor 210. One skilled in the art will recognize that there are possibly many other components of a computer system 100 that are not illustrated in FIG. 1. For example, a typical computer system 100 will often include one or more processors, random access memory, various buses, network interfaces, and other components. Users of the product management system, including category experts and administrators of the product management system, can use computer systems such as computer system 100 to interact with the product management system according to various embodiments. Alternative systems, such as a mobile phone, may also be used to access the product management system according to various embodiments.

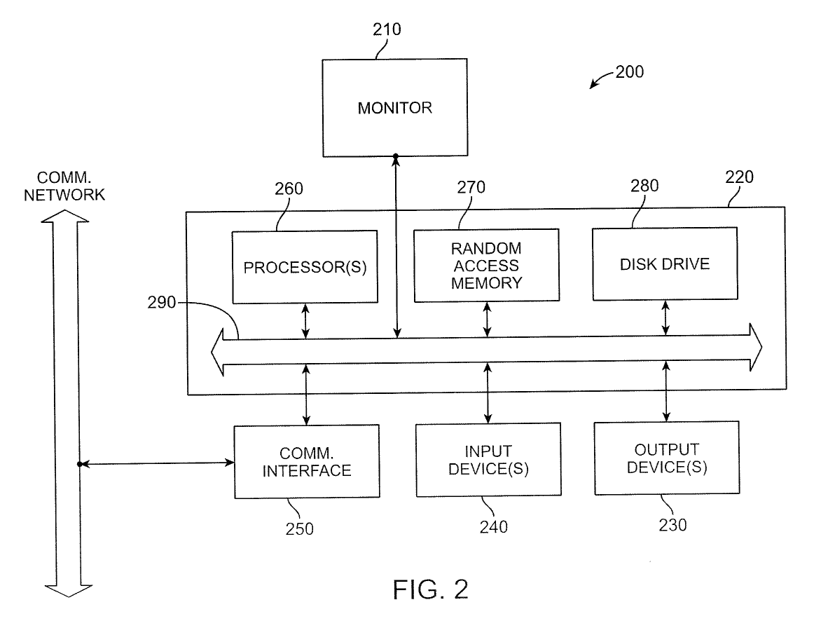

FIG. 2 is a simplified block diagram of a computer system 200 that may incorporate embodiments of the present invention. FIG. 2 is merely illustrative of an embodiment incorporating the present invention and does not limit the scope of the invention as recited in the claims. One of ordinary skill in the art would recognize other variations, modifications, and alternatives. For example, embodiments of computer system 200 that are used as database servers may or may not have a monitor 210 associated with the system.

In one embodiment, computer system 200 typically includes a monitor 210, a computer 220, user output devices 230, user input devices 240, communications interface 250, and the like.

As shown in FIG. 2, computer 220 may include a processor(s) 260 that communicates with a number of peripheral devices via a bus subsystem 290. These peripheral devices may include user output devices 230, user input devices 240, communications interface 250, and a storage subsystem, such as random access memory (RAM) 270 and disk drive 280.

User input devices 230 can include various possible types of devices and mechanisms for inputting information to a computer 220. These may include a keyboard, a keypad, a touch screen incorporated into the display, audio input devices such as voice recognition systems, microphones, and other types of input devices. In various embodiments, user input devices 230 are typically embodied as a computer mouse, a trackball, a track pad, a joystick, wireless remote, drawing tablet, voice command system, eye tracking system, and the like. User input devices 230 typically allow a user to select objects, icons, text and the like that appear on the monitor 210 via a command such as a click of a button or the like.

User output devices 240 can include various possible types of devices and mechanisms for outputting information from computer 220. These may include a display (e.g., monitor 210), non-visual displays such as audio output devices, etc.

Communications interface 250 provides an interface to other communication networks and devices. Communications interface 250 may serve as an interface for receiving data from and transmitting data to other systems. Embodiments of communications interface 250 typically include an Ethernet card, a modem (telephone, satellite, cable, ISDN), (asynchronous) digital subscriber line (DSL) unit, FireWire interface, USB interface, and the like. For example, communications interface 250 may be coupled to a computer network, to a FireWire bus, or the like. In other embodiments, communications interfaces 250 may be physically integrated on the motherboard of computer 220, and may be a software program, such as soft DSL, or the like.

In various embodiments, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 220 includes one or more Xeon microprocessors from Intel as processor(s) 260. Further, one embodiment, computer 220 includes a UNIX-based operating system.

RAM 270 and disk drive 280 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 270 and disk drive 280 may be configured to store the basic programming and data constructs that provide the functionality of the present invention.

Software code modules and instructions that provide the functionality of the present invention may be stored in RAM 270 and disk drive 280. These software modules may be executed by processor(s) 260. RAM 270 and disk drive 280 may also provide a repository for storing data used in accordance with the present invention.

RAM 270 and disk drive 280 may include a number of memories including a main random access memory (RAM) for storage of instructions and data during program execution and a read only memory (ROM) in which fixed instructions are stored. RAM 270 and disk drive 280 may include a file storage subsystem providing persistent (non-volatile) storage for program and data files. RAM 270 and disk drive 280 may also include removable storage systems, such as removable flash memory.

Bus subsystem 290 provides a mechanism for letting the various components and subsystems of computer 220 communicate with each other as intended. Although bus subsystem 290 is shown schematically as a single bus, alternative embodiments of the bus subsystem may utilize multiple busses.

FIG. 2 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

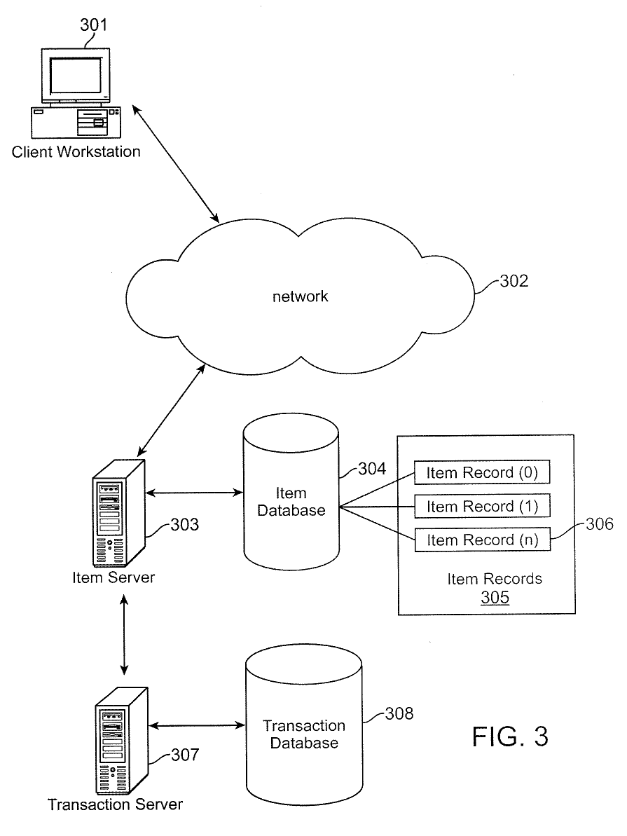

FIG. 3 is a schematic diagram of a network over which an embodiment of the present invention may be used. A user may use client workstation 301 to communicate with item server 303 through network 302. In one embodiment, the network 302 is the Internet. Item server 303 is coupled to item database 304 and is capable of reading, writing and modifying item database 304. It should be understood that the item server, like any other server well known in the art, may actually be comprised of many different computers all available to perform a common function, such as providing access to a database.

Item database 304 contains a table of item records 305. Item records can further be organized into categories in the item database. Item record 306 represents one item record or one page from item records 305. Each item record in item database 304 is associated with a SKU number. As used herein, the “term item record” and “SKU” are interchangeable. The term “SKU” may also be used for the item the SKU refers to. Often times, the item the SKU refers to is presented to the user, along with other information, in the form of a web page or other similar presentation means.

At a high level, each SKU within item database 304 is homesteaded by a user of the invention. When a SKU is homesteaded by a user, the SKU is claimed by the user, and an ownership interest in the SKU is given to the user. As used herein, the terms homesteaded, claimed, owned, or variants thereof all refer to this concept. A SKU owned by the user can be referred to as a homesteaded item. When a user homesteads a SKU, the user gains the potential for earning revenue off of that SKU.

A user can acquire a SKU ownership interest, and thus a financial interest, in a SKU in a variety of ways. One such way is for a user to add an item that is not currently listed in item database 304. Another way is for a user to correct, improve, enhance or otherwise “perfect” an existing item, thereby laying claim to it. Other methods may also exist for users to obtain an ownership interest in a SKU. For example, in some embodiments a user can acquire a SKU ownership interest by trading for the interest from another user.

Another method for a user to acquire an financial interest is to become a category expert. A category expert is much like a securities analyst in the stock market or a subject matter expert in the technology world. The category experts may write reports on the categories they cover to provide analysis and guidance to help users make informed decisions whether to buy, sell, or hold some specific items. The report may contain a product review, valuation opinion, and/or answers to questions posted by users. A portion of the category revenue may be allocated to the experts for sharing knowledge, driving traffic, and/or raising the performance of a category that satisfies the needs of the community.

Additionally, a category expert may create categories and construct the taxonomy associated with the category. The category expert can define the attributes that distinguish one SKU from another SKU within the category and define the relationships among the various attributes of the SKUs in the category. Once the category is published to users, the category expert can review and approve SKUs submitted by users for inclusion in the category and ultimately to the item database 304. A SKU may be placed into a “pending” table for review and approval/rejection. This pending table may be periodically reviewed by a category expert, catalog administrator, other reviewing entity who can review that submission and either approve or reject it. If approved, the user can be notified, and at that point the user will officially own the SKU and can start deriving future revenue from it. It is at this point the user becomes a homesteader for that particular item. In one embodiment, the relationship between a SKU Owner and a SKU can be stored in the Item Database 304 in a table of associations. If the submission is rejected, then the user may or may not receive an opportunity to resubmit the SKU depending on the quality of the initial submission.

A user can be a homesteader, a category expert, or other person with interest in a SKU or category all at the same time, and as a result, there are many different incentives given to a user to become an active, productive, participating member of the community. Additionally, the ability for a user to play many different roles within the system allow for users to have much control over how the system is organized and how the system can grow.

Revenue related to a SKU typically comes from one of two sources: buying/selling transactions between users involving a SKU and advertising revenue received from third-party accounts. This revenue can be collected in a central location. For example, FIG. 3 shows a transaction server 307 that can be used to process transactions and track revenue related to SKUs. The transaction server 307 has a connection with the item server 303 and the transaction server 307 is coupled to a transaction database 308. In one embodiment, the transaction database 308 can maintain a table of transactions that associates revenue with SKUs. In one embodiment, when a revenue-generating transaction related to SKU passes through the transaction server 307, the transaction server 307 can query the item server 303 to find the owner of the SKU in the transaction. Additionally, the transaction server 307 can look up one or more category experts associated with one or more categories associated with the SKU. A revenue sharing engine can analyze the collected revenue and distribute payouts to sponsors, SKU owner, category experts, or other parties.

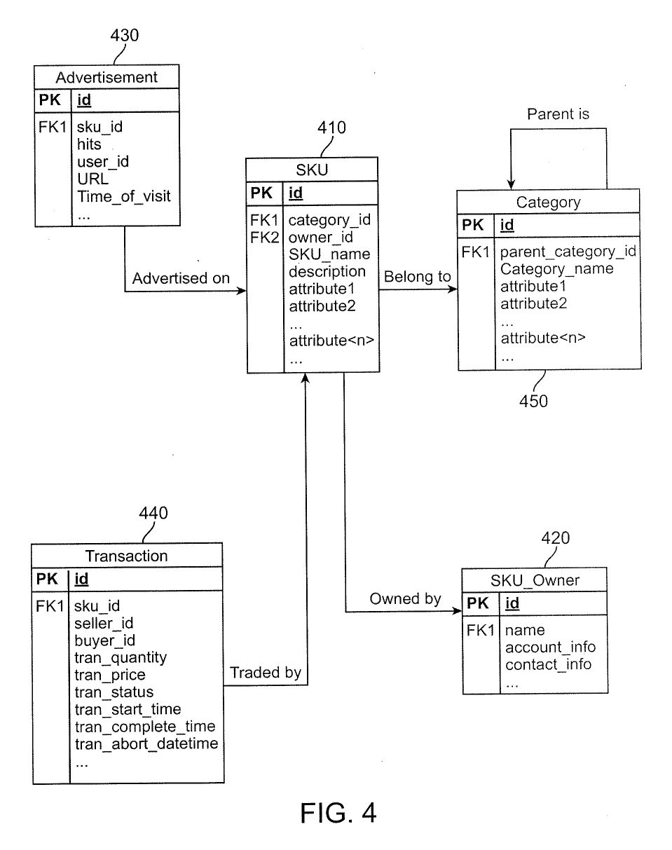

FIG. 4 is a simplified block diagram of an example item database structure which an embodiment of the present invention may use. The database structure tracks information related to SKUs as well as sets up relationships between SKUs, categories, and other aspects of the invention. For example, SKUs can be related to SKU owners, category information, and revenue information. The database structure may reside completely or partially in the item database 304, transaction database 308, or in any other suitable repositories.

Block 410 represents the SKU itself. Each SKU entry contains a list of attributes that describe the SKU in detail. For example, information about the manufacturer, model number or name, color, price, etc., of the SKU may be stored.

Additionally, each SKU entry contains information that links the SKU to a variety of other pieces of information. For example, the SKU can contain a reference linking the SKU to the SKU_Owner 420. Advertising 430 and transaction 440 tables can also link to the SKU so that revenue generated by this SKU can be uniquely tracked. SKUs may also belong to a category 450 and these categories may be subordinate to one or more “parent” categories as well. This category information can be stored in a category table. The category table may be stored in the item database 304 or in another database. The branch within the category tree which a SKU belongs to may determine the specific attributes that are required for that SKU. The category may also have one or more category experts associated with the category.

In the disclosure below, various actions that a category expert may take are described in detail. For example, a category expert may create categories, define the attributes associated with SKUs within a category, and accept SKUs to be associated with their categories. One skilled in the art will recognize that these actions can be effectuated using a database structure such as the one illustrated in FIG. 4 using well-known database techniques.

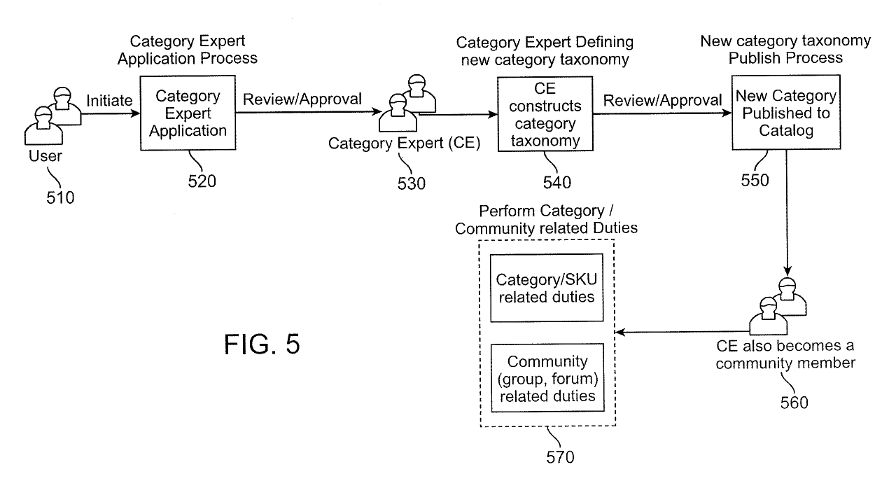

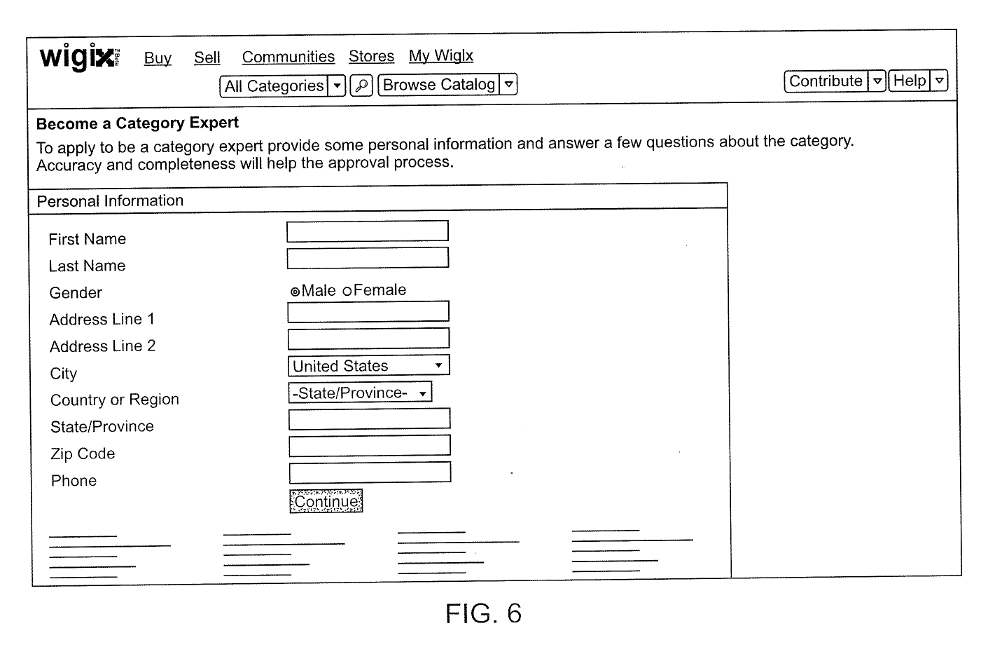

FIG. 5 is an illustration of the process in which any member of the general public can apply to become a category expert according to various embodiments. The steps outlined in FIG. 5 will be described in conjunction with illustrations in FIGS. 6-16 that will help to provide more details on category experts. The illustrations presented in FIGS. 6-16 may be presented to a user using any one of a variety of means. For example, according to one embodiment, a form can be presented to a user in a web browser running on the user's personal computer. The web browser may also be run from a browser running on a portable device, such as a cell phone or a personal digital assistant. Alternatively, a specific client application may be used by the user to access various forms.

According to various embodiments, a user 510 that wishes to become a category expert may fill out an application to become a category expert. This application process is shown at 520. During this process, information is collected from the user 510 so that a product management system administrator can properly judge whether the user 510 would make a good category expert for the category applied for by the user 510.

FIG. 6 is an example form that illustrates how the general public can apply to become a category expert using the category expert application process 520 according to one embodiment. In the form illustrated in FIG. 6, basic personal information from the user 510 is collected. Such information includes the user's name, gender, address, and other personal information. Alternative embodiments may collect other personal information.

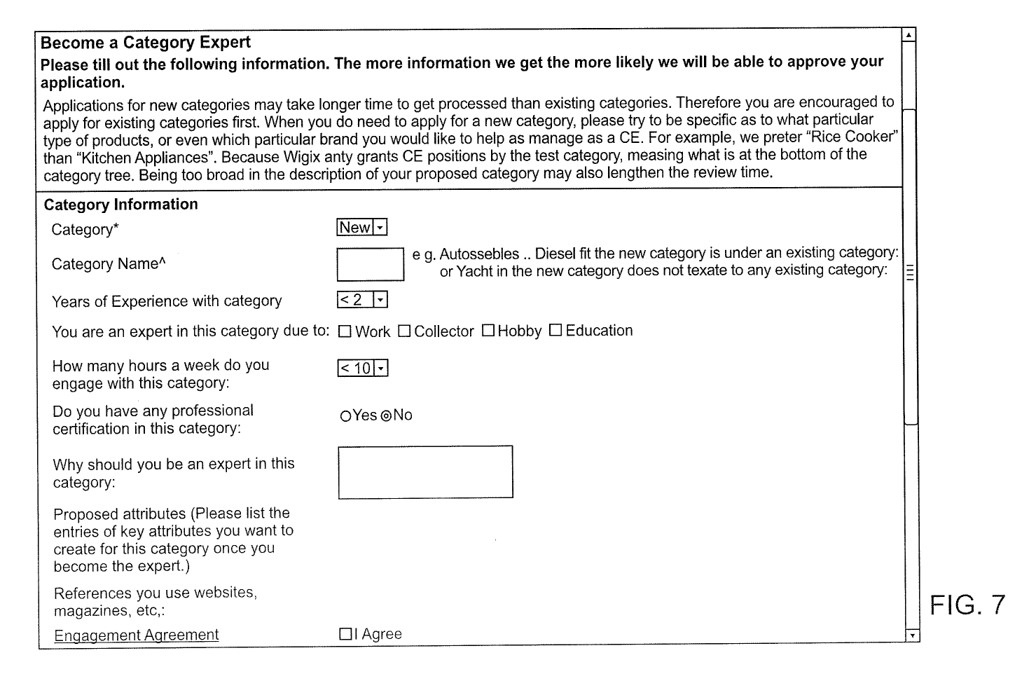

FIG. 7 is an example form that illustrates a second form in the category expert application process 520 according to one embodiment. The form in FIG. 7 illustrates various fields that category expert candidates fill out to provide an administrator with information regarding the candidates' qualifications and expertise for a particular category. The form illustrated in FIG. 7 differs from the form illustrated in FIG. 6 by collecting category specific information. In FIG. 7, information such as year of experience, professional certifications, and other relevant pieces of information can be collected. Other embodiment may collect different sets of information from the example shown in FIG. 7. Additionally, different categories may collect different information. For example, the data collected to judge whether a user has sufficient expertise to become a category expert in automobiles may be very different than the data collected to judge whether a user has sufficient expertise to become a category expert in computers. A form, such as the one illustrated in FIG. 7, may reflect these differences between categories.

Application information collected using forms such as the ones illustrated in FIGS. 6-7 can then be forwarded to an administrator for evaluation and assessment of the candidate's qualification, expertise, background and experience.

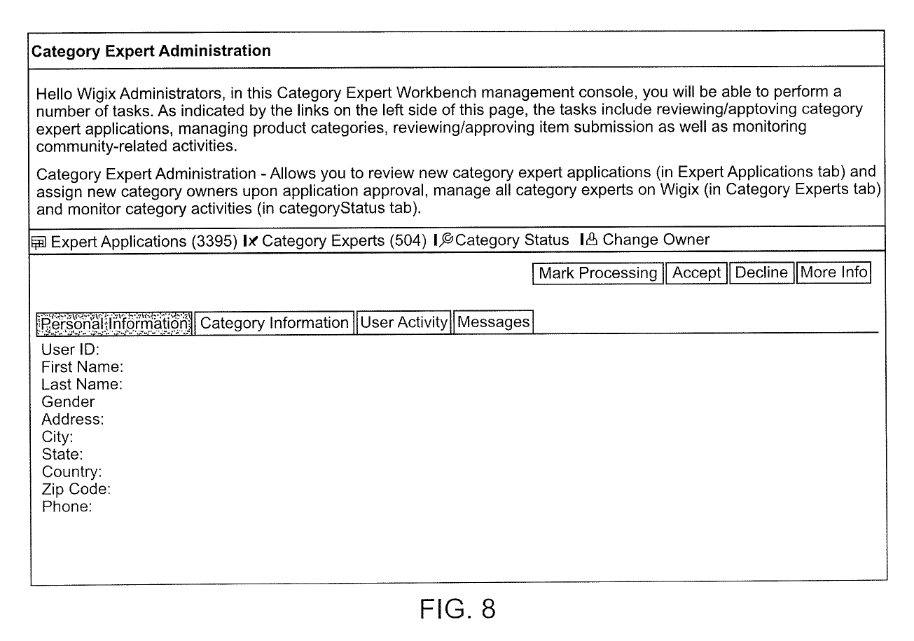

FIG. 8 is an illustration showing some of the informational content related to the category expert candidate that an administrator can review to approve or reject the application. In the example shown in FIG. 8, various tabs allow the administrator to view the various pieces of information entered by the candidate. Additionally, the administrator may be able to see other actions the user may have taken on the site (such as SKU sales, advice given, etc.) and may look at any relevant messages sent to the administrator. Other embodiments may present other information to the administrator to allow the administrator to judge whether the candidate would make a good category expert. After viewing the information, the administrator can accept or reject the candidate.

After a category expert is accepted by an administrator, the new category expert may undergo a tutorial to familiarize him- or herself on the application of the category expert workbench. The category expert workbench will be described in more detail later in this disclosure. Upon completion of the computer-based training, the individual will be assigned to the category he or she applies to manage as an expert.

Referring back to FIG. 5, a category expert 530 can then create categories for the expert's area of expertise and construct taxonomies associated with the categories. This is shown at step 540. A category expert can define the attributes that distinguish one product from another product within the category and define the relationships among the various attributes.

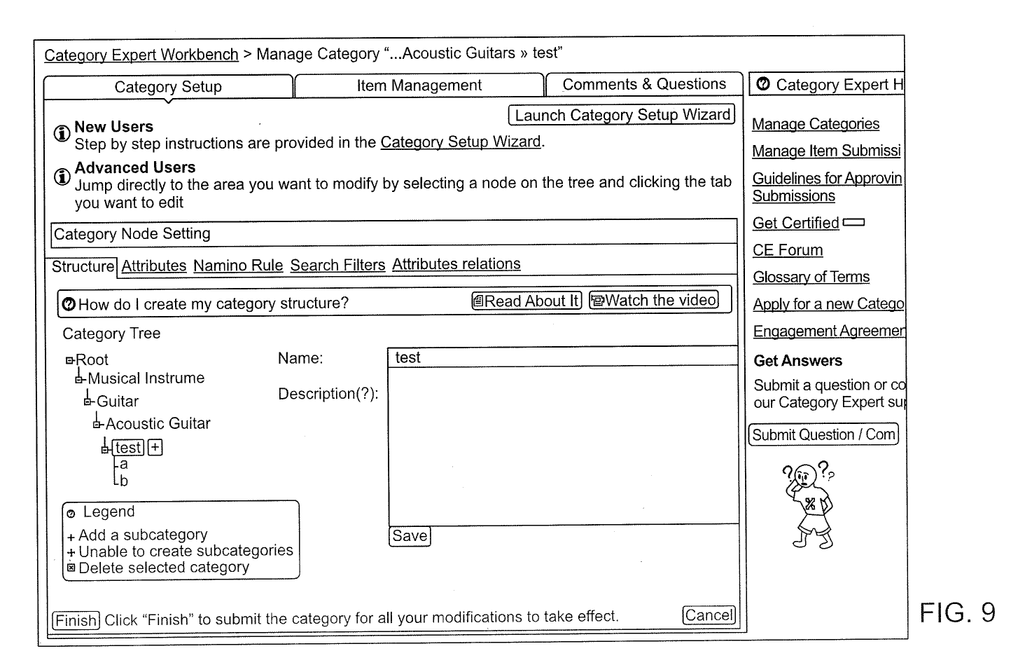

FIG. 9 is an illustration of an overall category management process according to various embodiments. According to various embodiments, a number of steps take place to create a category management structure and define the attributes for the product taxonomy.

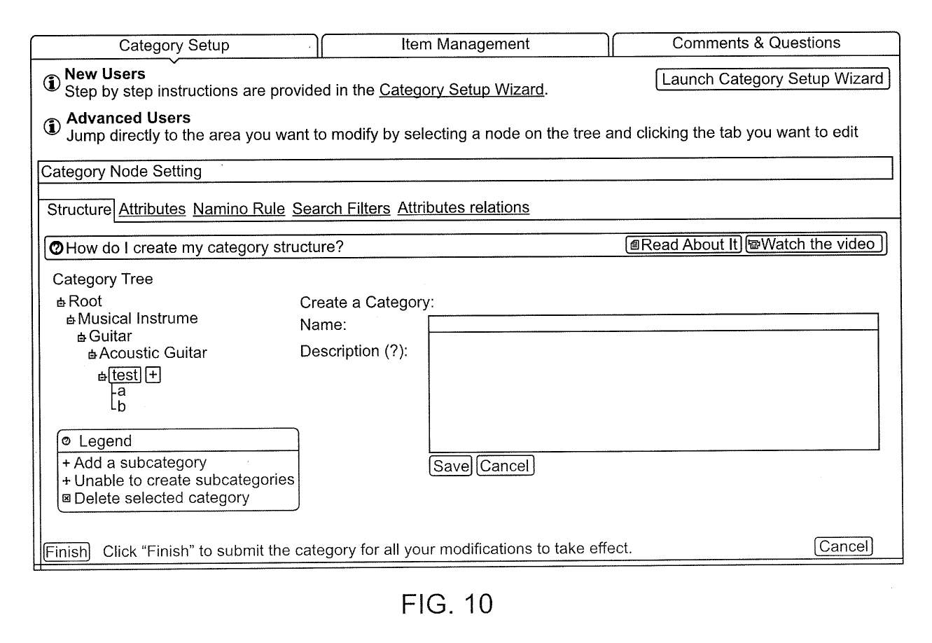

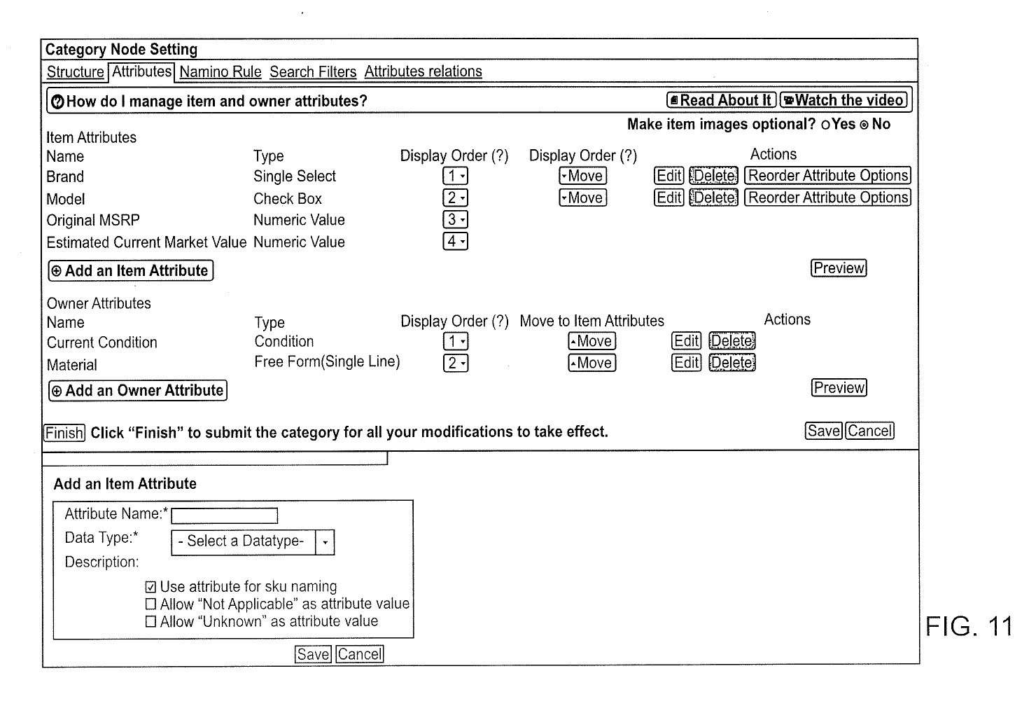

In the embodiment illustrated in FIG. 9, various tabs are provided to create a category node setting. The tabs illustrated in FIG. 9 are (i) structure, (ii) attributes, (iii) name rule, (iv) search filters, and (v) attribute relations. The functionality of these tabs is explained in more detail later in this disclosure. In addition, users can use either the category setup wizard or the “Watch the Video” help feature for step-by-step instructions to create a category. The creation of a category structure/taxonomy will be illustrated in more detail in FIG. 10; category attribute configuration will be illustrated in more detail in FIGS. 11-16.

FIG. 10 is an example form that illustrates the first building block in the creation of a category by a category expert. In FIG. 10, a category expert can create a new category by giving the category a name and a brief description. Additionally, a category expert may make a new category a sub-category of another category. In this fashion, the structure of the categories in the category management system can be created. The information entered by a category expert using a form such as the one illustrated in FIG. 10 may be stored in a category table, such as the one illustrated in category table 450 illustrated in FIG. 4.

FIG. 11 is an example form that illustrates an example of a template used to define various product attributes by a category expert. Product attributes are the attributes that can be associated with SKUs that are a part of the category. For example, if a category related to automobiles, some product attributes may include attributes such as the year, model, brand, and color of the car. Many other attributes may also be created as appropriate for a given category.

In FIG. 11, attributes may be any one of many different types. Some example attribute types may include: single select, check box, radio buttons, free form, numeric value, numeric range, and calendar. A single select attribute type allows a user to select one attribute from a list of attributes that can be presented to the user in a drop-down box. A check box attribute type allows a user to select one or more attributes from a set of attributes using a mechanism such as a check box. A radio type attribute is similar to a single select attribute type in that a user can select one value for the attribute, but with a radio type, the user may select an attribute value presented to the user as a set of radio buttons. A free form type allows a user to freely enter any attribute value they wish. A numeric value allows a user to enter a specific number for the attribute value, and typically a numeric value will be paired with an accompanying unit (e.g., inches, GHz, etc.). A numeric range is similar to a numeric value except that a range of numbers is given for the attribute value. A calendar attribute allows a user to select a specific date for the value. One skilled in the art will recognize that other attribute types may also be created according to various embodiments.

A description can be associated with each attribute defined by the category expert. A description can help explain what data should be entered for a specific attribute. This feature can be useful if the name of the attribute does not necessarily clearly communicate what data the attribute is meant to capture. For example, if an attribute was named “power” the description can explain that a user should enter the horsepower of a car rather than the available torque.

FIG. 11 further illustrates how a category expert can arrange attributes between item and owner-specific attributes. An item attribute is an attribute that applies generally to all SKUs within a category. For example, in a category that comprises various laptop computers from a particular manufacturer, item attributes might include the particular model of the laptop, the speed of the processor, the size of the screen, etc. Owner-specific attributes can then be used to give additional information that is relevant only to a specific item owned by a user. For instance, two laptops from the same manufacturers might have all of the same item attributes, but one laptop may be six months older than the other laptop. Owner-specific attributes can help users capture these differences in items. In both FIG. 11, a category expert has the ability to decide whether a defined attribute is an item attribute and an owner-specific attribute by putting or moving the attribute to the correct attribute sections. In addition, the order in which the attributes appear to the user can be arranged by a category expert.

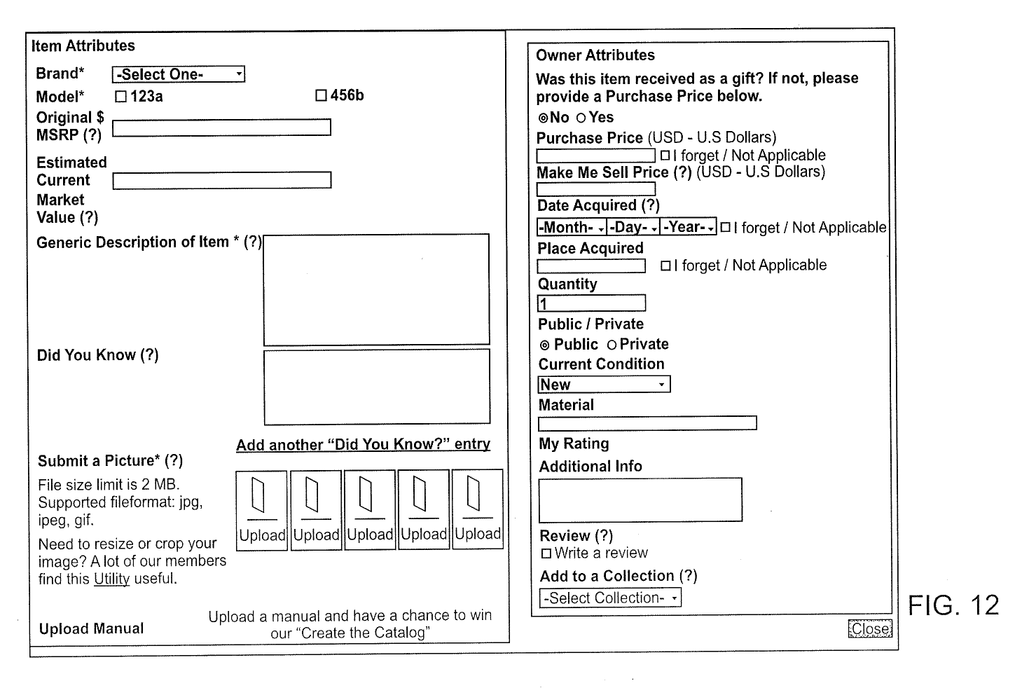

FIG. 12 is an example interface that illustrates a preview of item and owner-specific attributes for a category. In the example shown in FIG. 12, various item attributes, such as brand, model, general description, and picture have been created by a category expert. Additionally, various owner-specific attributes have been created, such as purchase price, date acquired, current condition, and others. The preview shown in FIG. 12 allows a category expert to see how the attributes will be presented to users when users create SKUs in the category.

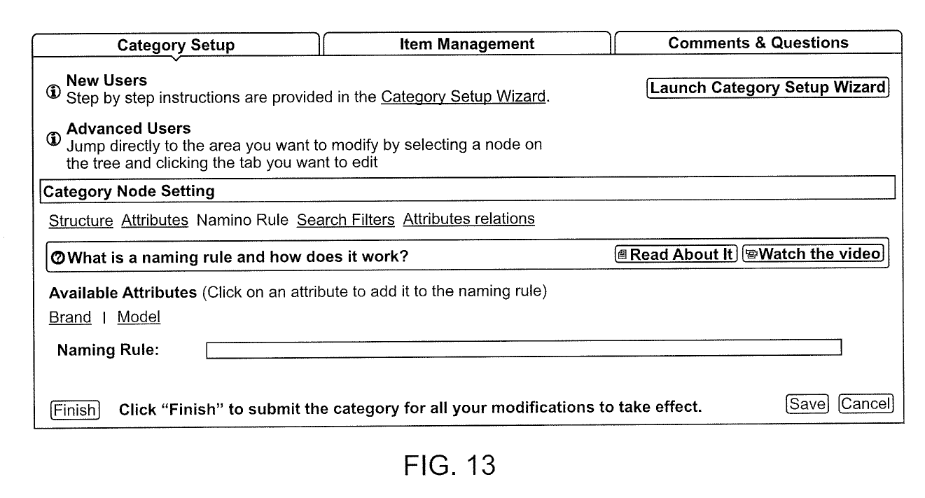

FIG. 13 is an example form that illustrates how attributes can be used to formulate rules used to name SKUs so that these names appear in an orderly fashion in the category. Selected attributes of a SKU may be used in the names of SKUs. For example, a category expert managing a category related to automobiles may decide that names of SKUs should contain the make and model and year of the SKU. The category expert can use a form, such as the one illustrated in FIG. 13, to create a rule that can be used to name SKUs. This rule can ensure that the make, model, and year of a SKU are consistently applied to name the SKUs in the category. In the embodiment illustrated in FIG. 13, the category expert can name the attributes used in SKU names between bracket delimiters. Additionally, the category expert can “hard code” aspects of the name by typing normal text in the naming rule field. One skilled in the art will recognize that there are many variations to the rule syntax that could be used according to various embodiments.

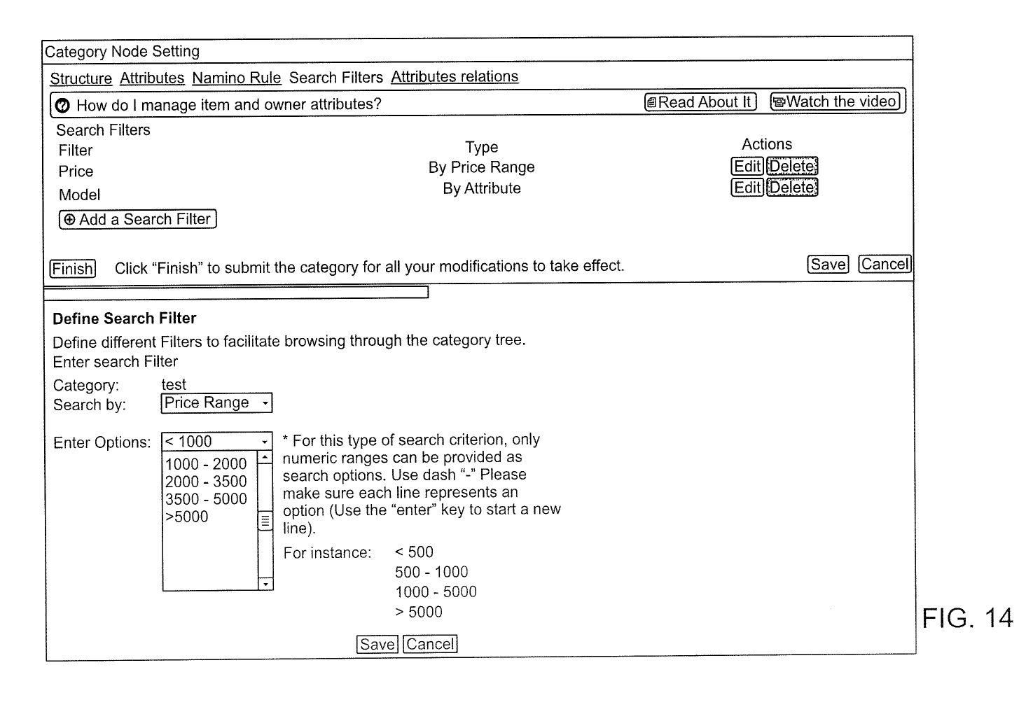

FIG. 14 is an example of a template used for defining how a category may be browsed or searched. For instance, users may browse SKUs in a category by brand, price, gender, or whatever characteristic that is defined by the category expert. In the embodiment illustrated in FIG. 14, the category expert is configuring various price ranges that may group SKUs in the category and be used by users to browse SKUs in the category.

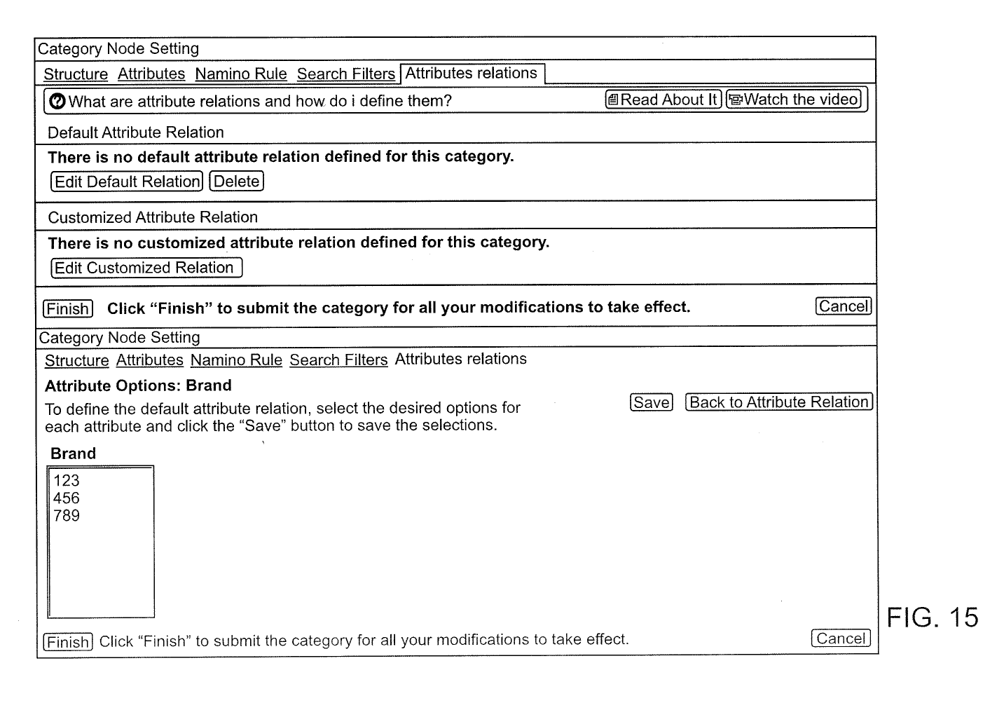

FIG. 15 illustrates a building block used to define how one attribute is related to another. A certain type of product may have a number of different manufactures, and each manufacturer may have a number of different models that they offer for sale. For example, in an automobile category, “Honda” and “Toyota” may be two different manufacturers of cars. The manufacturer of a car may be captured within a first attribute in a SKU. Additionally, a number of different car models exist for various manufactures. The model of a SKU may be captured within a second attribute in the SKU. Some models, such as “Corolla,” should be associated with the manufacturer “Toyota,” while other models, such as “Accord,” should be associated with the manufacturer “Honda.” Thus, certain values within the second attribute in a SKU should be associated with certain values in the first attribute of the SKU. A category expert can create these sorts of relationships between attributes using a form such as the one illustrated in FIG. 15.

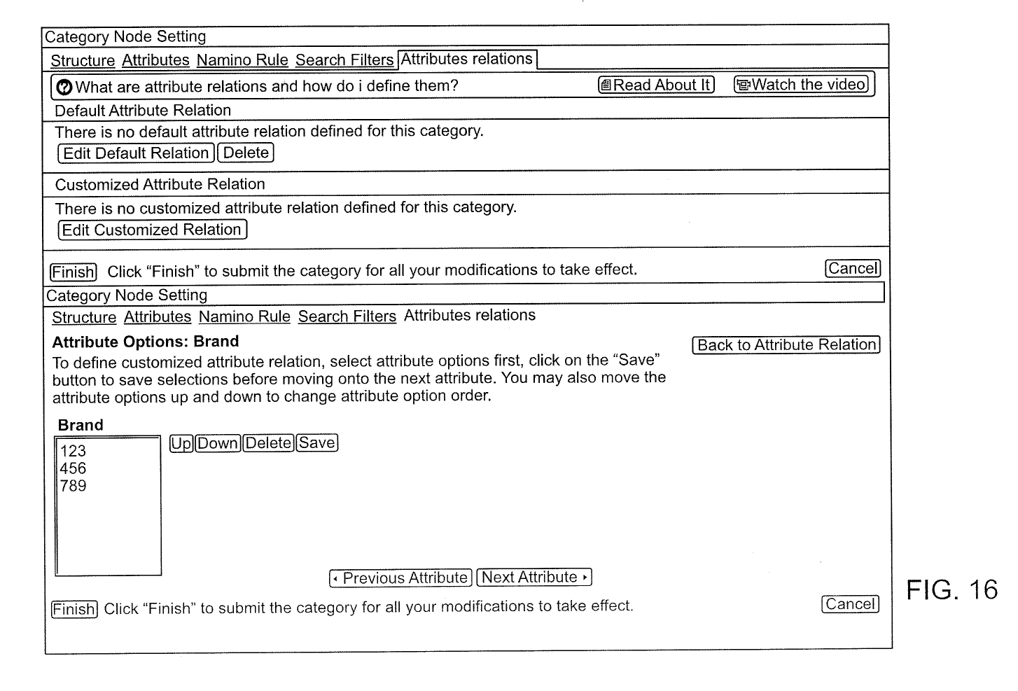

FIG. 16 is an example of a form that a category expert can use to arrange the order in which the attribute values appear to users. For example, in FIG. 16, a category expert has rearranged the brands “456,” “789,” and “123” so that “123” appears first. FIG. 16 is just one example of how a category expert can control how information is presented to a user within a category.

Now referring back to FIG. 5, after a category expert has constructed the taxonomy of a category at step 540, the category expert can submit the category for approval to an administrator. Once the administrator approves the category submitted by the category expert, the new category can be published to the community at large. This is shown at step 550.

Once the category is published, the category expert can review and approve the stock keeping units submitted by users for inclusion in the category and ultimately to the catalog. Once a category is published, users can create, trade, perfect, or take other actions in SKUs. Users may also discuss various topics related to the category in message boards associated with the category. Revenue generated from these activities can be shared between users, category experts, and other users as dictated by an appropriate revenue sharing scheme. Category experts themselves can also act as user in the community to buy, sell, or trade SKUs. Such a category expert is illustrated at 560.

Category experts also have many duties associated with their category. In one embodiment, a category expert workbench can be used by the category expert to carry out these duties. This is shown at 570. As mentioned previously, category experts have many duties associated with SKUs. For example, category experts have the duty to approve new SKUs submitted by users for their category. The category expert workbench can also be a tool that category experts use to communicate with owners, collectors, or interested parties on category activities and product information.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims. In addition, the technique and system of the present invention is suitable for use with a wide variety of methodologies for programming a device. The scope of the invention should, therefore, be determined not with reference to the above description, but instead should be determined with reference to the pending claims along with their full scope or equivalents.

What is claimed is:

1. An apparatus for managing one or more categories and one or more SKUs associated with the one or more categories, the apparatus comprising:
an item database; and,
an item server coupled to the item database, the item server capable of reading and modifying the item database;
wherein the item database comprises a table of categories and a table of SKUs;
wherein one or more SKUs stored within the table of SKUs is associated with one or more categories stored in the table of categories;
wherein a plurality of users has the ability to create one of more SKUs in the table of SKUs via the item server;
wherein a category expert is associated with one or more categories;
wherein the category expert has the ability to create and modify the one or more categories associated with the category expert within the table of categories via the item server;
wherein the category expert is one of the plurality of users.

2. The apparatus of claim 1 wherein the category expert has the ability to define one or more attributes of SKUs associated with the one or more categories associated with the category expert via the item server.

3. The apparatus of claim 2 wherein the one or more attributes include item attributes and owner-specific attributes.

4. The apparatus of claim 3 wherein the item attributes allow the plurality of users to create attributes for SKUs that may be shared between many different SKUs.

5. The apparatus of claim 3 wherein the owner-specific attributes allow the plurality of users to create attributes for SKUs that are specific to the SKUs created by a user.

6. The apparatus of claim 1 wherein the category expert has the ability to define relationships between categories via the item server.

7. The apparatus of claim 1 wherein the category expert has the ability to authorize the creation of any SKUs associated with the categories associated with the category expert, wherein the SKUs are created by the plurality of users.

8. The apparatus of claim 1 wherein the category expert has the ability to define one or more rules used to name SKUs associated with the categories associated with the category expert.

9. The apparatus of claim 8 wherein the one or more rules may include associating one or more attributes of SKUs with the name of SKUs.

10. The apparatus of claim 1 wherein one of the plurality of users becomes the category expert by submitting an application to an administrator of the apparatus.

11. The apparatus of claim 1 wherein the plurality of users have the ability to buy and sell items associated with the SKUs.

12. A method for managing one or more categories and one or more SKUs associated with the one or more categories in a product management system, wherein the product management system comprises an item database and an item server, wherein the item server is coupled to the item database, wherein the item server is capable of reading and modifying the item database, wherein the item database comprises a table of categories and a table of SKUs, the method comprising:
giving a category expert the ability to create and modify one or more categories in the table of categories, wherein the category expert is selected from a plurality of users;
publishing the one or more categories to the plurality of users so that the plurality of users have permission to view the one or more categories; and
giving the plurality of users the ability or create one or more SKUs in the table of SKUs, wherein the SKUs are associated with the one or more categories.

13. The method of claim 12 wherein the category expert has the ability to define one or more attributes of SKUs associated with the one or more categories associated with the category expert via the item server.

14. The method of claim 13 wherein the one or more attributes include item attributes and owner-specific attributes

15. The method of claim 12. wherein the category expert has the ability to define relationships between categories via the item server.

16. The method of claim 12 wherein the category expert has the ability to authorize the creation of any SKUs associated with the categories associated with the category expert, wherein the SKUs are created by the plurality of users

17. The method of claim 12 wherein the category expert has the ability to define one or more rules used to name SKUs associated with the categories associated with the category expert

18. The method of claim 17 wherein the one or more rules may include associating one or more attributes of SKUs with the name of SKUs.

19. The method of claim 12 wherein one of the plurality of users becomes the category expert by submitting an application to an administrator of the product management system.

20. The method of claim 12 wherein the plurality of users have the ability to buy and sell items associated with the SKUs.

21. A computer readable medium comprising computer executable code for carry out the method of claim 12 on a computer.
